(19) United States
(12) Patent Application Publication
(10) Pub. No.: US 2012/0094601 A1
(43) Pub. Date: Apr. 19, 2012

(54) BLUETOOTH HEADSET WITH CAMERA FUNCTION AND REAR VIEW MONITOR SYSTEM EMPLOYING THE SAME

(75) Inventor: JIAN-HUI LI, Shenzhen (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/963,774

(22) Filed: Dec. 9, 2010

(30) Foreign Application Priority Data
Oct. 14, 2010 (CN) 201010508284.7

(51) Int. Cl. H04B 7/00

(52) U.S. Cl. 455/41.2

(57) ABSTRACT

A Bluetooth headset includes a camera circuit, a radio frequency circuit and an antenna. The camera circuit includes a lens module and an image processing circuit electrically connected to the lens module. The lens module is for capturing and obtaining images, and the processing circuit is for processing the images from the lens module. The radio frequency circuit is electrically connected to the camera circuit, and the antenna is electrically connected to the radio frequency circuit. The radio frequency circuit processes the images from the image processing circuit, and the processed images from audio frequency circuit are transmitted to a portable electronic device through the antenna for the purpose of display. A rear view monitor system employing the Bluetooth headset is also described.

### BACKGROUND

1. Technical Field

The disclosure generally relates to Bluetooth headsets and rear view monitor systems, and more particularly relates to, a Bluetooth headset with camera function and a rear view monitor system employing the same.

2. Description of the Related Art

Parking distance control (PDC) systems are commonly employed for safely parking vehicles, and use ultrasonic proximity detectors embedded in the front and rear of the vehicles, to measure the distances to nearby obstacles. The sensors of the PDC system measure the time taken for each sound pulse to be reflected back to the receivers. Depending on the speed of the vehicle and the distance to the obstacles, the system can warn the driver by visual and/or audible means about the risk of accidents.

However, since the system relies on the reflection of sound waves, it may not detect some items that are not flat or large enough to reflect sound, for example, a narrow upright pole or a pole-like object pointed directly at the vehicle. Moreover, if the obstacles are small spherical items or are located at a low level (e.g., ditch), the system may be unable to receive the reflected sound waves, resulting in greater risk of accidents.

Therefore, there is room for improvement within the art.

### BRIEF DESCRIPTION OF THE DRAWINGS

Many aspects of an exemplary Bluetooth headset with camera function and rear view monitor system employing the same can be better understood with reference to the following drawings. The components in the drawings are not necessarily drawn to scale, the emphasis instead being placed upon clearly illustrating the principles of the exemplary Bluetooth headset with camera function and rear view monitor system employing the same. Moreover, in the drawings, like reference numerals designate corresponding parts throughout the several views. Wherever possible, the same reference numbers are used throughout the drawings to refer to the same or like elements of an embodiment.

FIG. 1 is a block view of a rear view monitor system including a Bluetooth headset, according to an exemplary embodiment.

FIG. 2 is a schematic view of the Bluetooth headset as shown in FIG. 1.

### DETAILED DESCRIPTION

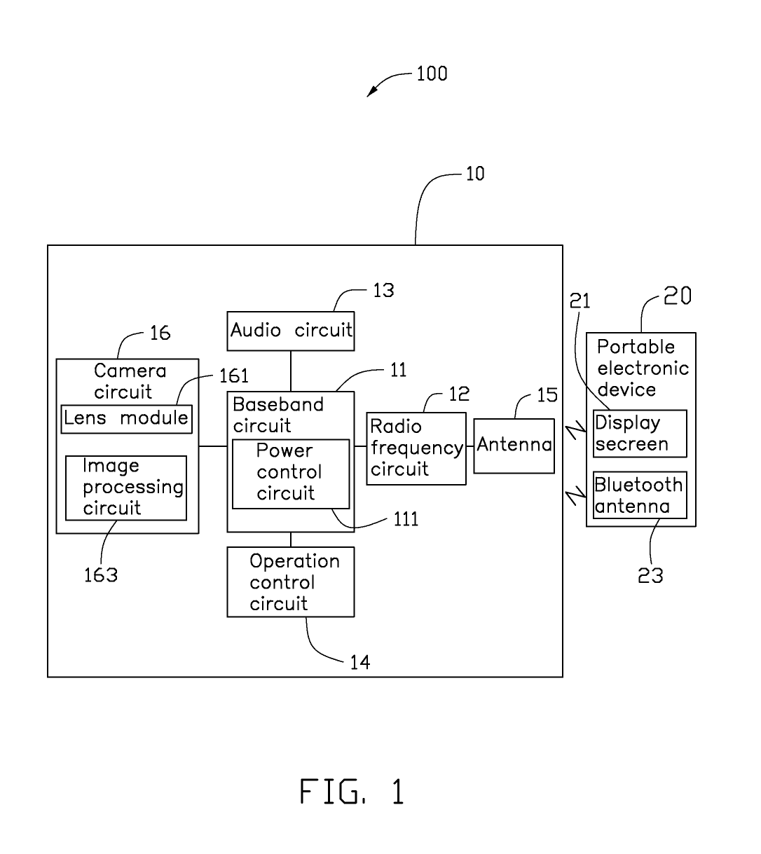

FIG. 1 shows a rear view monitor system 100, according to an exemplary embodiment, used on a road vehicle which can enable the driver to observe unseen obstacles behind the vehicle during parking or backing the vehicle. The rear view monitor system 100 includes a Bluetooth headset 10 with camera function and a portable electronic device 20.

The Bluetooth headset 10 can be used as a typical Bluetooth earpiece, which can communicate with other Bluetooth devices in a suitable distance. The Bluetooth headset 10 can also be used as a separately mounted camera on the rear of the vehicle. When the driver parks or backs the vehicle, the Bluetooth headset 10 can photograph and capture images of the area immediately behind the vehicle, which are then transmitted to and displayed on the portable electronic device 20 to view and monitor the area to the rear of the vehicle in real time. The Bluetooth headset 10 includes a baseband circuit 11, a radio frequency (RF) circuit 12, an audio circuit 13, an operation control unit 14, an antenna 15, and a camera circuit 16.

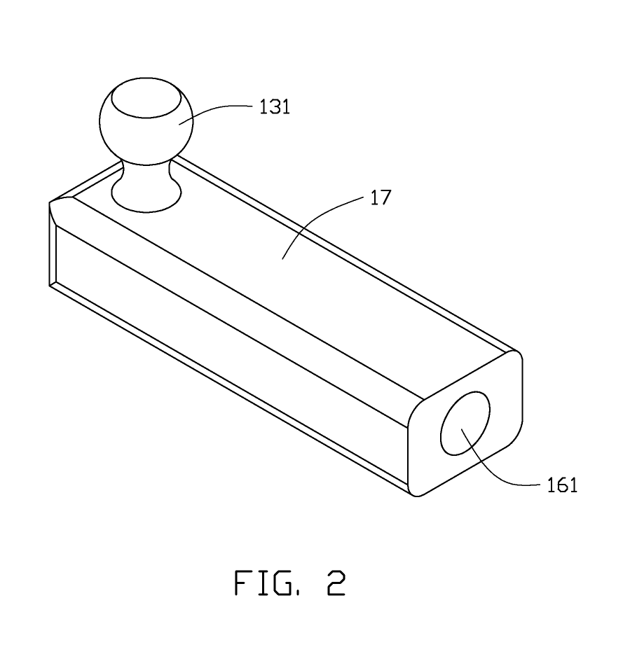

Also referring to FIG. 2, the Bluetooth headset 10 includes a main body 17, and the baseband circuit 11, the RF circuit 12, the audio circuit 13, the operation control unit 14, the antenna 15, and the camera circuit 16 are received within the main body 17. The baseband circuit 11 includes a micro control unit (MCU) and is capable of providing and transmitting a command signal to control the Bluetooth headset 10. The baseband circuit 11 further includes a power control circuit 111, which is capable of power storage and providing power for the Bluetooth headset 10.

The RF circuit 12 is electrically connected to the baseband circuit 11 and the antenna 15. The antenna 15 can be a Bluetooth antenna and is capable of receiving and sending different wireless signals including audio and/or image data. The RF circuit 12 receives the wireless signal including audio and/or image data from the antenna 15 and then filters, amplifies and processes the wireless signals. The processed wireless signals are transmitted to the portable electronic device 20 by the antenna 15.

The audio circuit 13 is electrically connected to the baseband circuit 11 and is capable of receiving, processing and transmitting audio signals. The audio circuit 13 includes an earpiece 131 and a microphone (not shown), and the earpiece 131 is located at an end of the main body 17.

The operation control unit 14 is electrically connected to the baseband circuit 11 and can be a human computer interaction (HCI) circuit, which can improve user friendliness of the Bluetooth headset 10. The operation control unit 14 includes different function circuits, such as a power switch circuit and a volume control circuit, to input and provide different operation commands to the Bluetooth headset 10.

Further referring to FIG. 2, the camera circuit 16 is electrically connected to the baseband circuit 11 and includes a lens module 161 and an image processing circuit 163 electrically connected to the lens module 161. The lens module 161 is mounted within another end of the main body 17 relative to the earpiece 131 and is capable of obtaining and capturing images. The image processing circuit 163 includes an image processor for processing images from the lens module 161, which are then transmitted to the portable electronic device 20 through the RF circuit 12 and the antenna 15 for viewing in real time.

The portable electronic device 20 can be a mobile phone, a personal digital assistant (PDA) or other wireless communication device, which includes a display screen 21 and a Bluetooth antenna 23. The Bluetooth antenna 23 receives the image signals from the Bluetooth headset 10. The display screen 21 displays the images from the Bluetooth antenna 23.

In use, when parking or backing the vehicle, the operation control unit 14 is operated to enable the Bluetooth headset 10 to work, and the Bluetooth headset 10 communicates with the portable electronic device 20. The Bluetooth headset 10 is adjustably positioned on the rear of the vehicle and aimed according to driver preference, and the lens module 161 is actuated to capture images accordingly. The images are then transmitted from the Bluetooth headset 10 to the portable electronic device 20 and are displayed on the display screen 21. Thus, the user can view and monitor the area to the rear of the vehicle in real time, to better avoid accidents.

In addition, in order to facilitate the placement of the Bluetooth headset 10, the rear view monitor system 100 further includes a camera holder (not shown), which is fixed on the rear of the vehicle. The camera holder is capable of securing and supporting the Bluetooth headset 10 and is adjustable to aim the Bluetooth headset 10 as desired.

In summary, the camera circuit 16 of the Bluetooth headset 10 can capture images of the area immediately behind the vehicle, the images are then transmitted to the portable electronic device 20 and are displayed on the display screen 21. The Bluetooth headset 10 is adjustable and is aimed according to driver preference. Thus, the rear view monitor system 100 can monitor and display the area to the rear of the vehicle in real time, providing a more reliable rear view monitoring system 100 that is not limited to obstacles that can reflect sound waves.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A Bluetooth headset, comprising:
a camera circuit comprising:
a lens module for capturing and obtaining images; and
an image processing circuit electrically connected to the lens module, the image processing circuit for processing the images from the lens module;
a radio frequency circuit electrically connected to the camera circuit; and
an antenna electrically connected to the radio frequency circuit, wherein the radio frequency circuit processes the images from the image processing circuit, and the processed images from the radio frequency circuit are transmitted to a portable electronic device through the antenna.

2. The Bluetooth headset as claimed in claim 1, further comprising a main body, wherein the radio frequency circuit, the antenna and the camera circuit are received within the main body.

3. The Bluetooth headset as claimed in claim 2, further comprising a baseband circuit electrically connected to the radio frequency circuit and the camera circuit, wherein the baseband circuit is located within the main body and is capable of providing a command signal to control the camera circuit.

4. The Bluetooth headset as claimed in claim 3, wherein the baseband circuit comprises a power control circuit, the power control circuit is for power storage and providing power for the Bluetooth headset.

5. The Bluetooth headset as claimed in claim 3, further comprising an audio circuit electrically connected to the baseband circuit, wherein the audio circuit is capable of receiving and processing and transmitting audio signals.

6. The Bluetooth headset as claimed in claim 5, wherein the audio circuit comprises an earpiece, the earpiece is located at an end of the main body relative to the lens module.

7. The Bluetooth headset as claimed in claim 1, further comprising an operation control unit electrically connected to the baseband circuit, wherein the operation control unit comprises different function circuits to provide and input different operation commands for the Bluetooth headset.

8. A Bluetooth headset, comprising:
a main body;
a camera circuit received within the main body, comprising:
a lens module located within an end of the main body, the lens module for obtaining and recording wireless signals including images; and
an image processing circuit electrically connected to the lens module, the image processing circuit for processing the wireless signals including images from the lens module;
a radio frequency circuit located within the main body and electrically connected to the camera circuit; and
an antenna located within the main body and electrically connected to the radio frequency circuit, wherein the radio frequency circuit filters, amplifies and processes the images from the image processing circuit, and the processed images from the radio frequency circuit are sent to a portable electronic device through the antenna for the purpose of display.

9. The Bluetooth headset as claimed in claim 8, further comprising a baseband circuit electrically connected to the radio frequency circuit and the camera circuit, wherein the baseband circuit is located within the main body and is capable of providing a command signal to control the camera circuit.

10. The Bluetooth headset as claimed in claim 9, wherein the baseband circuit comprises a power control circuit, the power control circuit is for power storage and providing power for the Bluetooth headset.

11. The Bluetooth headset as claimed in claim 9, further comprising an audio circuit electrically connected to the baseband circuit, wherein the audio circuit is capable of receiving and processing and transmitting audio signals.

12. The Bluetooth headset as claimed in claim 11, wherein the audio circuit comprises an earpiece, the earpiece is located at the end of the main body relative to the lens module.

13. The Bluetooth headset as claimed in claim 8, further comprising an operation control unit electrically connected to the baseband circuit, wherein the operation control unit comprises different function circuits to provide and input different operation commands for the Bluetooth headset.

14. A rear view monitor system employing the Bluetooth headset as claimed in claim 1, comprising:
a Bluetooth headset detachably and adjustably located at a vehicle, the Bluetooth headset for obtain and capture images of the area immediately behind the vehicle; and
a portable electronic device communicating with the Bluetooth headset, wherein the portable electronic device comprises a display screen, the portable electronic device receives the images and displays the images on the display screen to view and monitor the area to the rear of the vehicle in real time.

15. The rear view monitor system as claimed in claim 14, wherein the Bluetooth headset further comprises a main body, the radio frequency circuit, the antenna and the camera circuit are received within the main body.

16. The rear view monitor system as claimed in claim 15, wherein the Bluetooth headset further comprises a baseband circuit electrically connected to the radio frequency circuit and the camera circuit, and the baseband circuit is located within the main body and is capable of providing a command signal to control the camera circuit.

17. The rear view monitor system as claimed in claim 16, wherein the baseband circuit comprises a power control circuit, the power control circuit is for power storage and providing power for the Bluetooth headset.

18. The rear view monitor system as claimed in claim 16, wherein the Bluetooth headset further comprises an audio circuit electrically connected to the baseband circuit, and the audio circuit is capable of receiving and processing and transmitting audio signals.

19. The rear view monitor system as claimed in claim 18, wherein the audio circuit comprises an earpiece, the earpiece is located at an end of the main body relative to the lens module.

20. The rear view monitor system as claimed in claim 14, wherein the Bluetooth headset further comprises an operation control unit electrically connected to the baseband circuit, and the operation control unit comprises different function circuits to provide and input different operation commands for the Bluetooth headset.
